(19) United States
(12) Patent Application Publication
(10) Pub. No.: US 2008/0279271 A1
(43) Pub. Date: Nov. 13, 2008

(54) Very High Speed Low Power Receiver Equalization System For Non-Return-To-Zero Transmission

(76) Inventors: Philippe Hauviller, Itteville (FR); Alexandre Maltere, Montgeron (FR)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 11/621,229

(22) Filed: Jan. 9, 2007

(30) Foreign Application Priority Data
Sep. 1, 2006 (JP) 06300017.8

(51) Int. Cl. H04L 27/01

(52) U.S. Cl. 375/232

(57) ABSTRACT

A very high speed low power receiver equalization system for non-return-to-zero transmission is disclosed. The equalizer comprises a three stage architecture, preferably controlled by three main parameters, the low frequency gain controlled through Rfb, the peaking frequency settled by the capacitor Cfpk, and the variable peak boosting Gpk which provides the equalizer transfer function and the optimum controls of the signal gain characteristic in order to compensate the ISI at the receiver input and consequently allow High speed, reliable links.

### FIELD OF THE INVENTION

The present invention relates generally to the transmission of very high speed signals between integrated circuits and more specifically to a very high speed low power receiver equalization system for non-return-to-zero transmission.

### BACKGROUND OF THE INVENTION

With the increasing frequency of the signals used in modern communication link, unwanted effects such as cross talk, ringing, reflection, offset, and Inter Symbol Interference (ISI) occur. Such effects mainly result from the distributed nature of the media transporting the signals and from the lack of sufficient bandwidth of the media.

A major parameter in high speed wired communication is the ISI, also called data pattern dependent Jitter. ISI penalty is the combination result of low media bandwidth, limited driver device performance, package, connectors, and due to relatively large signal bandwidth implied by Non-Return-To-Zero (NRZ) data. In high speed data transfer, the large frequency range presented by the data excites the media in a large portion of its characteristics, usually around (and sometimes passes) the cutting frequency i.e., several Giga Hertz. This is especially critical for non-encoded data, where the covered frequency range varies from almost DC to some Giga Hertz i.e., the rated link rate.

The most important for a link to operate is to get an open EYE before the data get sampled for latter processing. The EYE opening range, in timing and amplitude, is critical to predict and to maintain an acceptable Bit Error Rate. The ISI at high speed is a major contributor to the EYE closure, and so, it is critical for the data link reliability. The problem is well known by those skilled in the art (high speed link designers) since it is a very strong limitation for high speed applications.

FIG. 1, comprising FIGS. 1a, 1b, 1c, 1d, and 1e, illustrates the transmission of a signal through a media, or data path. According to FIG. 1a, the signal S₁ is transmitted from the driver 100 to the receiver 105 through the differential data path 110. Due to the load capacitance C1 spread out along the entire data path, the transmitted signal S₁ is degraded forming, for example, signals S₂ and S₃, as depicted. Once received by the receiver 105, the signal S₃ is amplified (signal S₄) and then sampled in the sampler 115 to recover the data (signal S₅). FIG. 1b shows an example of the attenuation of the signal along the media when the frequency varies. According to such illustrated transfer function that characterizes most of the data paths, the high-frequency signals are highly corrupted by the media and therefore, they need to be reconstructed, if not too degraded. Dotted arrow illustrates the media signal attenuation for a particular signal frequency. FIG. 1c depicts an example of a portion of the signals S₁ to S₅. As mentioned above, signal S₁ represents the signal to be transmitted, signals S₂ and S₃ illustrate the influence of load capacitance C1 on signal S₁, signal S₄ shows the amplification of signal S₃ performed in the receiver 105, and signal S₅ shows the transmitted data recovered in sampler 115. FIGS. 1d and 1e illustrate the eye diagram corresponding to signals S₃ and S₄, respectively. As it is apparent, the amplification increases the amplitude of the signal but it does not increase the eye opening referred to as Op. on the drawing i.e., it does not reduce the ISI. BC corresponds to the Bit Cell.

There are basically two techniques for reducing the ISI, the driver pre-compensation (one should rather say pre-distortion) and the receiver equalization. The driver pre-distortion offers usually a lower leverage compared to a receiver equalization. The driver pre-distortion is difficult to tune since only the receiving device can estimate the signal quality so that the receiving device is more capable of tuning its local equalizer. The amount of pre-distortion is usually done though simulation, but the correct prediction requests an accurate modeling of the media, for each application. Recently some complex architecture shows an upstream signal quality technique to enable a tuning loop from receiver die to transmitter die. This of course means that both dies comes from the same maker.

FIG. 2 shows an eye diagram corresponding to signal S₃ after equalization. As shown, the eye opening is increased, reducing the ISI. Assuming the equalizer is boosting the data fundamental frequency (half of the data rate), the media and driver attenuation at high frequency is reduced. Consequently, transitions are boosted and the equalizer output EYE is enlarged. For example 6 dB attenuation can be compensated by a 6 dB boosting. Considering the receiver equalization, the main problem for high speed link is to be able to equalize at such high frequency. The usual gm/C technique is limited to the Giga Hertz and is relatively large and power consuming. It is then not suitable for high speed and especially not for numerous channels.

The benefit of Equalization was clearly demonstrated, since the equalizer was able to reopen a closed EYE as shown on FIG. 2, and provides a free error sampling window up to 40% UI (Unit Interval which is the bit duration). However the gm/C biquad is power consuming, approximately 3 mA at 320 Mbits/s. A quick estimation of the power consumption running a gm/C equalization at 2.5 Gbits/s, shows that the power would need to be 64 times higher since the transconductance gm is proportional to the square root of the bias current (gm is the Jds current gain versus the Vgs).

At fast data rate e.g., above 2 Gbit/s, the sampling window (depending upon the eye diagram) is so much reduced that the Error Rate is prohibitive to get a reliable and even an operating link. The receiver equalization technique is already used at lower frequency (for example SCSI-PI5 runs at 320 Mbit/s, but using up to 20 meter cable connect).

Therefore, there is a need for a very high speed low power receiver equalization system for non-return-to-zero transmission to equalize signal at high frequency and reasonable power.

### SUMMARY OF THE INVENTION

Thus, it is a broad object of the invention to remedy the shortcomings of the prior art as described here above.

It is another object of the invention to provide a very high speed low power receiver equalization system for non-return-to-zero transmission.

It is a further object of the invention to provide a very high speed low power receiver equalization system for non-return-to-zero transmission that is adapted to compensate two thirds to three quarters of the input ISI.

It is still a further object of the invention to provide a very high speed low power receiver equalization system for non-return-to-zero transmission that strongly improves the link reliability and reduces the dependency to the media length, quality and transmitter performance.

The accomplishment of these and other related objects is achieved by a low power equalizer for high speed signals having three amplifying stages serially connected, comprising a negative feedback loop from the third stage output to the second stage input for controlling the ISI, wherein,

the first stage is adapted to isolate the upstream circuit from said feedback;

the second stage comprises means for adjusting its variable gain with inherent common mode stabilization, for controlling signal peak boosting; and,

the third stage comprises means for applying the feedback to control the ISI by offering a gain peaking capability.

Further advantages of the present invention will become apparent to the ones skilled in the art upon examination of the drawings and detailed description. It is intended that any additional advantages be incorporated herein.

### BRIEF DESCRIPTION OF THE DRAWINGS

FIG. 1, comprising FIGS. 1a, 1b, 1c, 1d, and 1e, illustrates the transmission of a signal through a media according to the prior art.

FIG. 2 shows an eye diagram corresponding to signal S₃ of FIG. 1, after equalization.

FIG. 3 illustrates the structure of the equalizer of the invention that contains three stages.

FIGS. 4 and 5 depicts an example of the structure of the stages of the equalizer shown on FIG. 3.

FIG. 6 depicts the effects of the three main parameters of the equalizer on the signal gain.

FIG. 7 comprises FIG. 7a, FIG. 7b, and FIG. 7c. FIG. 7a shows a simplified schematic of the simulation bench developed to optimize and demonstrate the capability of the proposed equalizer. FIGS. 7b and 7c illustrate the main circuit values, optimized according to the simulation bench of FIG. 7a, for obtaining the results shown on FIGS. 10 and 11, respectively.

FIG. 8 illustrates the capability to balance the manufacturing process tolerance and operating conditions influence on the peaking frequency by controlling the capacitance Cfpk.

FIG. 9 represents the signal gain versus the frequency for four different values of peak boosting Gpk.

FIG. 10, comprising FIGS. 10a and 10b, shows ISI rejection and eye “re-opening”, for the equalizer optimized for operating at 2.5 Gbit/s, respectively.

FIG. 11, comprising FIGS. 11a and 11b, shows ISI rejection and eye “re-opening”, for the equalizer optimized for operating at 6 Gbit/s, respectively.

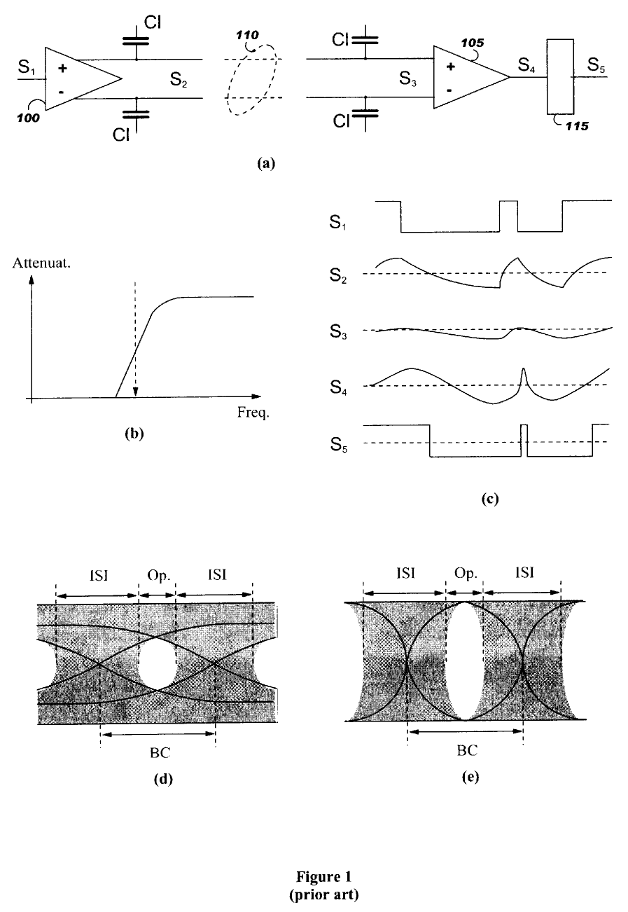

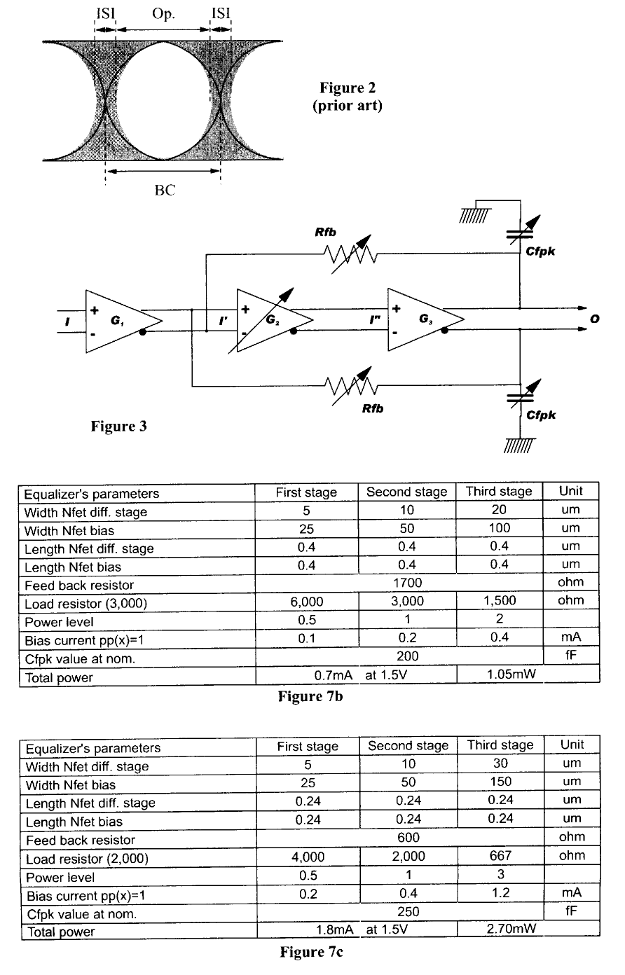

### DETAILED DESCRIPTION OF THE PREFERRED EMBODIMENT

The main idea of the present invention is based upon the Cherryhooper technique known to be able to enlarge amplifier bandwidth. As opposed to the usual implementation where a flat gain frequency response is wanted, the peaking at high frequency is here desired for building the equalizer transfer function so as to implement a programmable peaking in the gain transfer at the particular data rate (or line rate). In order to optimize the equalizer transfer function, which implies to simulate the ISI generated during a data transfer through a media model, one can demonstrate that the transfer function needs to be tunable for modulating the ISI compensation depending upon the perturbation i.e., the ISI at the input of the receiver device. The main parameters comprise the peak frequency, peak gain and global gain. These three parameters are preferably programmable so as to be adjusted according to the signals to deal with and according to the tolerance of the technology used for the circuit implementation.

It is critical to control the peak gain since the gain must be reduced for relatively low ISI distortion otherwise the ISI would be higher after equalization. Naturally, the peak gain needs to be increased as the input ISI to correct is higher i.e., the peak gain needs to be modulated as a function of the input ISI. Controlling the global gain prevents saturation and it allows larger range of input amplitude. It is recommended to be attenuated at low frequency in order to increase the relative low/high frequency gain peaking even more. Likewise, controlling the peak frequency is critical since the peak frequency must be kept at half the data rate. A peak frequency compensation must be done according to the operating environment, in particular according to the temperature and to the manufacturing process tolerance of the equalizer. In addition the frequency range can be made relatively large to cover multiple applications.

The disclosed invention is easily applicable to data rate up to 6 Gbit/s using 0.12 um Cmos technology (as shown on FIG. 11). Such structure would require about 3 mW (at 6 Gbit/s). There is no doubt that this structure can be pushed over 10 Gbit/s using faster devices e.g., Ultra thin oxide devices or 0.09 um technology. It could also be easily translated to bipolar or SOI technology.

### Equalizer Architecture

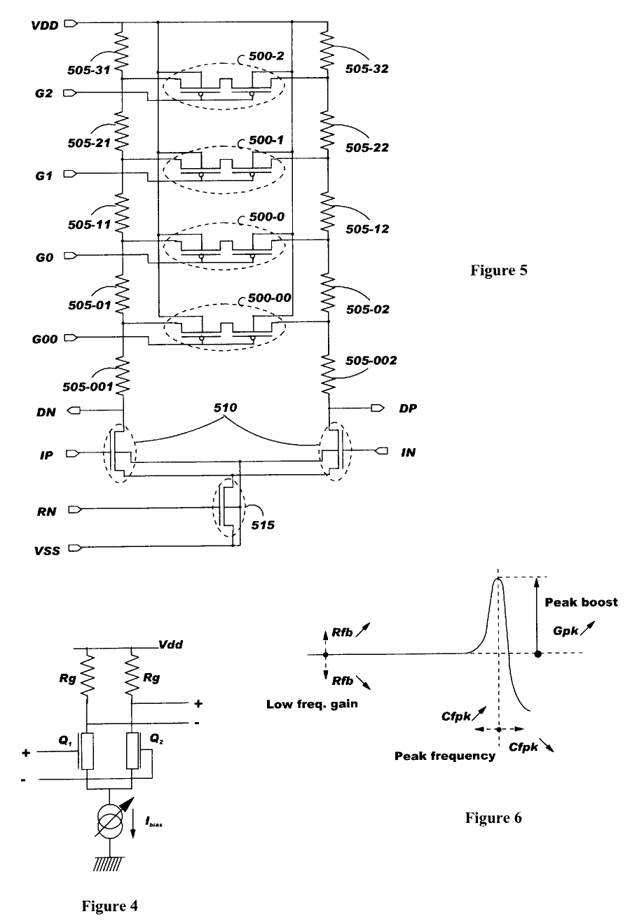

As illustrated on FIG. 3, the equalizer of the invention contains three stages, referred to as G₁, G₂, and G₃. All stages are using resistive loads to get fast speed and good linearity, as depicted on FIGS. 4 and 5.

For sake of illustration, the signals are differential signals however, it must be noticed that it is not required and so, the equalizer of the invention can be implemented to handle single-ended signals.

Each stage comprises a dual path input and a dual path output which means that each stage comprises a pair of input terminals and a pair of output terminals. In each pair of terminals, one terminal is referred to as a positive terminal and the other terminal is referred to as a negative terminal. The differential signal I to be equalized is input in the first stage G₁ through its input terminals. The output I′ of the stage G₁ is then input in the second stage G₂ that output is referred to as I″. To that end, the positive output terminal of G₁ is connected to the positive input terminal of G₂ and the negative output terminal of G₁ is connected to the negative input terminal of G₂. The output I″ of the second stage G₂ is in turn input in the third stage G₃ having the output O i.e., the positive output terminal of G₂ is connected to the positive input terminal of G₃ and the negative output terminal of G₂ is connected to the negative input terminal of G₃. The input I′ of the second stage G₂ is connected to the output O of the third stage G₃ through resistor Rfb, the dual path being swapped i.e., the positive input terminal of G₂ is connected to a resistor Rfb that second terminal is connected to the negative output terminal of G₃ and the negative input terminal of G₂ is connected to a second resistor Rfb that second terminal is connected to the positive output terminal of G₃. This build a negative feed back which is responsible for lowering the gain at low frequency. In addition, the negative and positive output terminals of the third stage G₃ are connected to the final high amplification stage (delivering full logic swing). Also, an adjustable capacitance Cfpk on each G₃'s output allows to tune the peaking frequency. The second terminal of these capacitors is connected to ground.

FIG. 4 illustrates the architecture of the first and the third stages that are similar. The input terminals of G₁ and G₃ are connected to the gate terminals of two transistors Q₁ and Q₂ that sources are connected to a single current source I_{bias}. For sake of illustration, the positive input is connected to the gate terminal of Q₁ and the negative input is connected to the gate terminal of Q₂. The drains of Q₁ and Q₂ are connected to Vdd through two identical resistors Rg. The stage output is connected to the drains of the transistors Q₁ and Q₂ in such a way that, if the gate terminal of a transistor is connected to the positive stage input, its drain is connected to the negative stage output, and vice versa. In the example of FIG. 4, the positive stage output is connected to the drain of Q₂ and the negative stage output is connected to the drain of Q₁.

FIG. 5 illustrates the architecture of the second stage G₂. The difference to the other stages is the gain G₂ adjustment capability. Its main advantage is to avoid modifying the common mode voltage (defined as DP+DN/2, wherein DP and DN are respectively the true/positive and the complement/negative output voltages), which means that the following stage biasing is constant. This optimizes the operation of the complete path. As illustrated on the drawing, the gain adjustment is controlled by four digital signals, G00, G0, G1, and G2 that each controls a couple of switches, generically referred to as 500. These couples of switches are able to short circuit, True to Complement output, to reduce the gain thought resistors generically referred to as 505. In the given example, only one switch needs to be active (low). The switches are made of Pfet devices which are sufficient since output bias is in the one Volt range (Nfet is of no use). Using only Pfet allows a compact layout and even to implement the polysilicon resistors over the Nwell of the Pfets to protect from substrate noise. A series of two Pfets 500 is used for each switch to minimize the coupling between the differential outputs, that swing in opposite ways. This improve the speed of this circuit. The differential pair, referred to as 510 and built with two Nfets, determines the gain range of the second stage. The Nfet device 515 generates the bias current I_{bias} of this stage using RN control signal.

Preferably, the first stage G₁ is lightly biased and consequently it comprises high resistor load. The first stage isolates the circuit input and upstream circuits from the third stage feedback. The second stage is twice powerful and, as mentioned above, it includes a programmable gain Gpk to set different peak boosting values. The third stage has a power of four, associated to the Rfb resistor it provides a negative feedback to the first stage. Consequently, the feedback reduces the low frequency gain. Reducing Rfb results in lowering the gain characteristic, to allow more input dynamic. The peaking frequency can be controlled by the Cfpk capacitor implemented at the third stage output.

### Functional Description:

The first stage and third stage just differ from the device sizes, which are larger for the third stage to allow more current and to be able to drive the load and feedback to the second stage. As opposed, the first stage needs a relatively higher resistor load in order to effectively apply the feedback from the third stage. Consequently, the transistor devices as well as the bias current in the first stage are smaller. There is an optimum trade-off between the device sizes, bias current, transient performance wanted gain and power consumption, which is to be determined for each technology. The input terminals of either G₁, G₂, or G₃ are connected to the gate terminals of two transistors Q₁ and Q₂ that sources are connected to a single current source I_{bias} which is build up by a relatively larger Nfet device. Q₁ and Q₂ drains are connected to resistive loads Rg implemented preferably using polysilicon resistors. The polysilicon resistor offers the optimum form factor in the 6 KOhms to 0.6 KOhms, optimizing the size to reduce the parasitic capacitance. The second advantage is that temperature coefficient is very small for such conductor layer, meaning that resistivity is approximately constant no matter what the temperature is. This is very important to maintain the operating point (biasing) at the optimum for high frequency operation. Q₁ and Q₂ devices build a differential stage and provide high frequency operation, high linearity, and low gain, associated to this resistive load. Once again high gain is not wanted but linearity and velocity are much in demand.

As discussed above, FIG. 4 illustrates the differential stage, the positive input is connected to the gate terminal of Q₁ and the negative input is connected to the gate terminal of Q₂. The drains of Q₁ and Q₂ are connected to Vdd through two identical resistors Rg. The stage output is connected to the drains of the transistors in such a way that, if the gate terminal of a transistor is connected to the positive stage input, its drains is connected to the negative stage output, and vice versa. This is a convention to make sure the stage does not invert the signal polarity. Using this convention makes the schematic cleaner and, as shown on FIG. 3, it becomes clear that the positive/negative output of the third stage connections swap the phase when connecting to the second stage input. Depending upon the voltage difference on the gates of Q₁ or Q₂ the current I_{bias} is shared in the two load resistors. The current I₁ in Q₁, and in the drain, I₂ for Q₂, sum up so that I₁+I₂=I_{bias}. When the Q₁ gate voltage is above the Q₂ gate voltage then I₁ is higher than I₂, and reverse if Q₂ gate voltage is higher than Q₁ gate voltage. At this point due the resistive load the voltage on the negative output is equal to Vdd−I₁×Rg and the positive output is Vdd−I₂×Rg. When Q₁ and Q₂ gate voltages are equal, the I_{bias} current is symmetrically shared among Q₁ and Q₂, which corresponds to the output common mode bias point Vdd−0.5×I_{bias}×Rg. This output bias point is set by choosing the appropriate Rg value for the wanted I_{bias} current. Choosing the bias current is important to optimize the transient or maximum frequency operation. When low gain is wanted, the size of Q₁ and Q₂ can be small and a reasonably low current bias is sufficient. In such a case, a low power consumption and good velocity can be accommodated. The gain of this differential stage defined as Vout/Vin, depends on the Q₁ or Q₂ transconductance gm and resistive load Rg. The transconductance gm depends on the device size (width/length) and is proportional to the square-root of the bias current. The transconductance gm is the gain defined by drain current (Jds) versus gate voltage (Vgs). In the example of FIG. 4, the bias current I_{bias} is build using a single transistor having at least 0.5 um length to increase the current source impedance. High impedance current source is desired in order to provide a relatively stable bias no matter the voltage fluctuations of the Q₁/Q₂ source.

The second stage G₂ structure as shown on FIG. 5 is implemented based on the Q₁ and Q₂ differential stage described above. The difference compared to the first or third stage is the resistive load, where the variable gain capability is offered. One skilled in the analog design knows that the gain could be modulated by changing the resistor load value Rg, which is not easy since, as discussed above, the common mode bias is Vdd−0.5.I_{bias}.Rg. Simply modifying Rg by multiplying it by a factor of 2 will affect a lot the bias to the following stages, so that the linearity and gain will be much affected. In order to reduce such unwanted distortion, a complex common mode control mechanism can be implemented. It would result in increasing the capacitive loading and would strongly impact the speed of the circuit. The proposed solution offers the variable gain capability without altering the common mode or DC bias. The next stage and all the circuits involved in this equalizer keep on being biased at the same exact level, due to the feedback to the input, no matter the gain selection from the second stage G₂. Only the portion of the resistor where the currents I₁ and I₂ are shared participates to the gain. The portion where I₁ and I₂ are merged (knowing I₁+I₂=I_{bias}) does not affect the gain, but the DC bias. Looking at FIG. 5, the two resistor loads Rg are shared in five pieces referred to as 505-001 and 505-002, 505-01 and 505-02, 505-11 and 505-12, 505-21 and 505-22, and 505-31 and 505-32, approximately one fifth of Rg each. Switches are implemented between each positive and negative taps of these two resistor ladders. Let's supposed that the first switch controlled by G00 is activated so that it shorts circuits arranged on the two sides of the ladder, consequently the series of resistors referred to as 505-31, 505-21, 505-11, and 505-01 are in parallel with resistors referred to as 505-32, 505-22, 505-12, and 505-02. The current I₁ and I₂ are merged in this node, the current in this short-circuited node is the total bias current I_{bias}. The currents I₁ and I₂ just flow in the resistors referred to as 505-001 and 505-002, so that the gain depends on these two resistors only, about ⅕ of the maximum gain (which is when all switches being off). The common mode voltage bias is then defined by the following equation,

Vcmd=0.5×(RG3+RG2+RG1+RG0)×I_{bias}+I₁×RG00+I₂×RG00

where RG3 is the value of resistors 505-31 and 505-32, RG2 is the value of resistors 505-21 and 505-22, RG1 is the value of resistors 505-11 and 505-12, RG0 is the value of resistors 505-01 and 505-02, and RG00 is the value of resistors 505-001 and 505-002.

The common mode is defined as DC bias, when the differential signal is nul, and thus I₁=I₂=I_{bias}/2 so that,

Vcmd=I_{bias}/2×(RG3+RG2+RG1+RG0+RG00)=I_{bias}/2×Rg.

As one can see, the common mode bias is constant, and the gain depends upon the portion of the ladder not short circuited by the switch(es). The first switch from the Q₁ and Q₂ drain that short-circuits the Rg ladders settles the gain magnitude, the other switches upper in the ladder could be either ON or OFF. This is driven by the simplicity of the decoder that controls the switches. The number of switches and the segmentation of the Rg ladder depends on the gain granularity and the maximum peaking gain. In practice, a 3 dB gain granularity and a maximum gain of 12 dB (4×) is a good compromise of performance versus complexity. As shown on FIG. 5, the switches are made of a series of two transistors in order to minimize the capacitive coupling between positive and negative outputs. Using a series of two devices puts the source/gate and drain/gate capacitors in series, and consequently divides by two the capacitance between the amplifier outputs. This is critical since both positive and negative outputs swing in opposed direction and consequently slow down each others. The transistors used for switch can just be Pfets, since the common mode is relatively high (about 1V), when pulling the Pfet gate at ground the Vgs is already much higher than the Pfet Vt, and efficiently turns the switch fully ON. The use of Nfet switch will not be as efficient, and it will not improve much to use complementary Nfet Pfet devices for the switch. The Pfet switches need to be implemented over Nwell biased at Vdd, this also offers the capability to place the Rg resistor ladders over this same Nwell, this improves the noise immunity by shielding the switch and resistor network from the substrate noise injection.

### Controlling the Equalizer'S Parameters

The equalizer of the invention can be tuned so as to optimize its response, in particular in function of the data rate, the process tolerance and the temperature. FIG. 6 depicts the effects of the three main parameters on the signal gain. As mentioned above, the three main parameters and the associated tunings are the low frequency gain tuned by the resistor Rfb, the peaking frequency set by the capacitor Cfpk, and the peak boosting controlled by Gpk. As shown on FIG. 6, the value of the resistor Rfb (in fact the ratio Rfb/Rg_{stg1} to the load resistor Rg of the first stage) is used to determine the gain characteristic and thus to adjust the equalizer to the input dynamic. Reducing the value of the resistor Rfb results in lowering the gain characteristic so as to handle input signal having greater dynamic, and vice versa. The capacitor Cfpk controls the peaking frequency of the signal gain. The higher Cfpk is, the lower is the peaking frequency of the signal gain, and vice versa. Finally, the second stage gain Gpk determines peak boosting of the signal gain. The higher Gpk is, the higher is the peaking or boosting of the signal gain.

Controlling the peaking frequency Cfpk to compensate the process and temperature

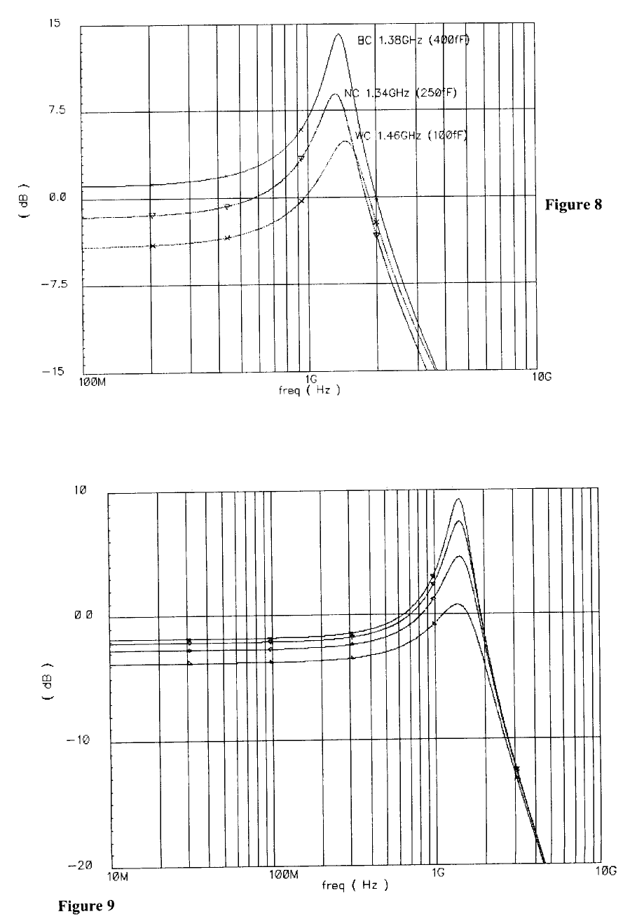

The equalizer peak frequency must be set to approximately half the data rate e.g., 1.25 GHz for 2.5 Gbit/s operation. In practice, it is usually set slightly above to be in the leading region and not in the low pass filter section. FIG. 8 illustrates the influence of the peaking frequency. FIG. 8 is a graph representing the signal gain versus the frequency. As shown, the capacitor Cfpk must be chosen so as to balance the process and temperature effects. In the example of FIG. 8, the peaking frequency is wanted at about 10% above the line operating rate (1.25 GHz+10%=1.4 GHz). At nominal conditions and nominal process Cfpk needs to be at about 250 fF and should be set at 100 fF at 0° C. and fastest process. At the opposite Cfpk should be set at 400 fF at 125° C. and slowest process. This then demonstrates the ability to control the peaking frequency even with these extremely large operating ranges.

Controlling the peak boosting Gpk using the gain of the second stage

The equalizer peak boost can be adjusted by selecting the appropriate Gpk from the second stage. In practice the boosting should be set depending on the ISI to correct. As a general rule, a high Gpk value should be used to control elevated ISI, and similarly the gain should be decreased when the input ISI is low. FIG. 9 represents the signal gain versus the frequency for four different values of Gpk. It is derivable from FIG. 9 that shows the maximum gain moving from +9, +7, +5, to +1 dB. In fact the important parameter to the ISI control is the difference between this maximum gain (Gpk) and the low frequency gain (G0). This is defined here as the peaking gain which are about Gpk−G0=9−(−2)=11 dB, then 9 dB, 7.5 dB, and 5 dB for the lower case.

### Results

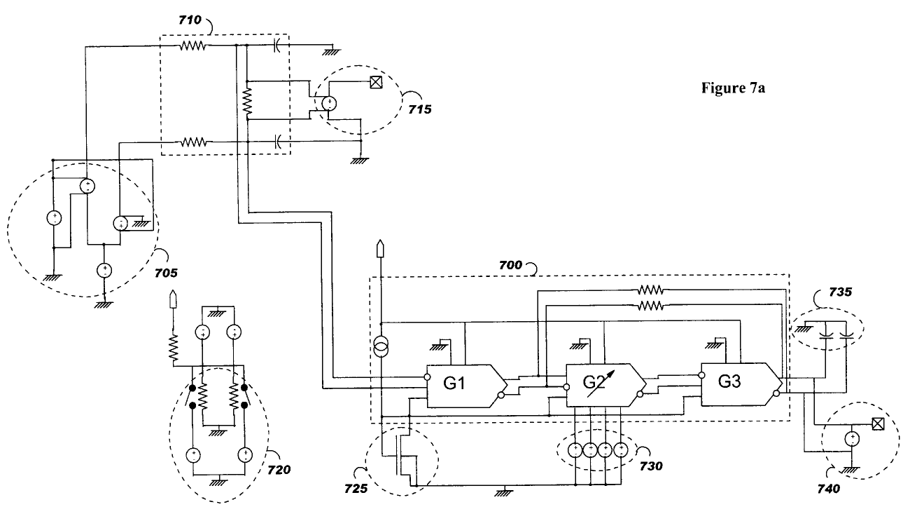

FIG. 7a describes the simulation bench, that includes the equalizer 700, an input generator pattern circuit 705 used to feed input data pattern computed from a user supplied bit stream, the modelling of the media 710, and a time base to be able to plot the EYE, not represented, (the EYE represents all the toggling events bounding the bit cell).

The bit duration is defined in the simulation and used by both input data stream and Time Base to plot the EYE.

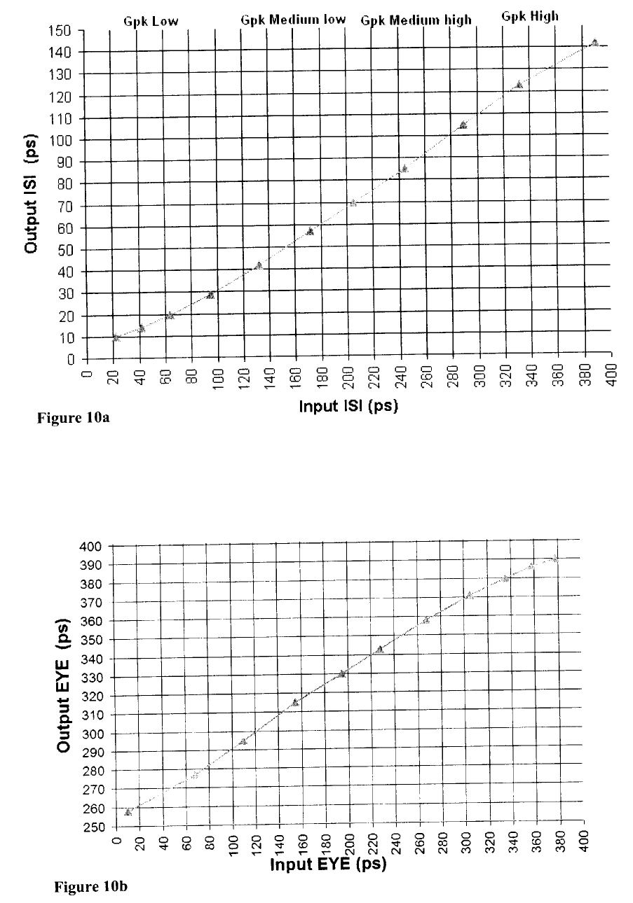

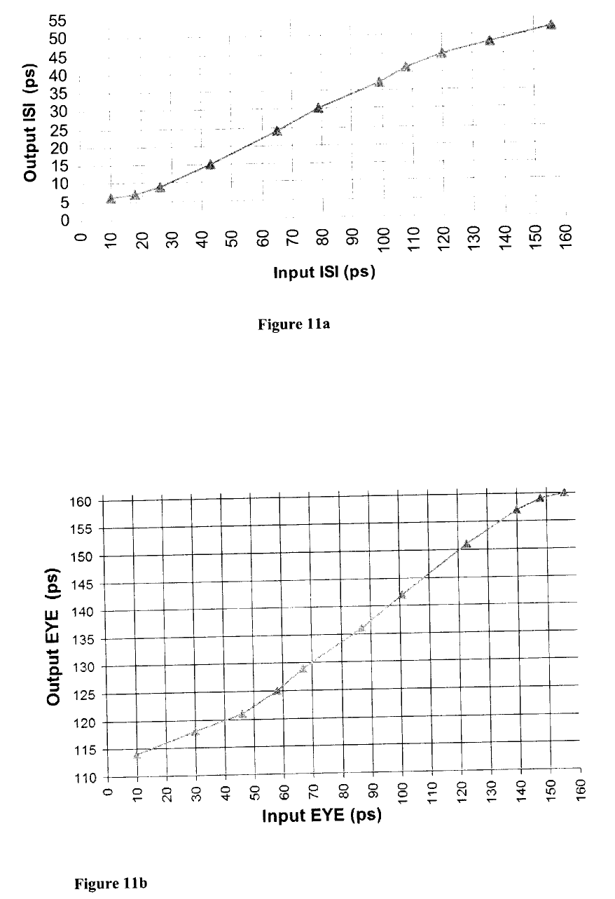

As illustrated, the media 710 (first responsible for the ISI on a link) is modelled as a Resistor-Capacitor first order filter. Increasing either the capacitor or the serial resistor results in increasing the input ISI to the equalizer input (this is measured by sensor 715 and reported on the X axis of both FIGS. 10 and 11). The EYE on the equalizer output (measured by sensor 740) is plotted in the simulation and reported on the Y axis of both FIGS. 10 and 11. FIGS. 10a and 11a show the equalizer ISI attenuation while FIGS. 10b and 11b illustrate the eye “re-opening”.

The input data pattern is critical to build. A devoted function was developed to be able to construct such complex wave. The pattern includes a long series of 0's or 1's in such way that a long run length up to 32 bits (31×1's then a single 1) and reverse and any other combinations (of 32 bits) up to 010101 full speed transitions are generated. Ultimately the pattern should be symmetrical to get a nice symmetry on the EYE plot. The bit duration, the rising/falling edges the amplitude are the other main parameters to guide to the transformation of the data into a wave for simulation, which is fed by circuit 705.

The simulation bench further comprises a differential input signal sensing circuit 715, a circuit 720 for injecting noise on power supply, a current bias circuit 725, a digital gain control circuit 730, a capacitive loading circuit 735 for emulating next stage and peak frequency control, and a differential output signal sensing circuit 740.

The tables of FIGS. 7b and 7c illustrate the main circuit values, optimized according to the simulation bench of FIG. 7a, for obtaining the results shown on FIGS. 10 and 11, respectively.

Controlling the ISI at 2.5 Gbit/s

FIG. 10a shows ISI rejection for the equalizer centered for operating at 2.5 Gbit/s and FIG. 10b illustrates the eye “re-opening”. The power consumption is about 0.7 mA when the equalizer is implemented using a 0.12 um technology. The equalizer peak boost Gpk is set to different values for optimizing the data dependent jitter depending on the input jitter magnitude. As mention above, Gpk, tuning the second stage G2, is set to a high value for controlling high ISI and Gpk (through G₂) is decreased for lower input ISI. As one can observed from FIG. 10a, the ISI rejection is almost linear removing about 70% of the input ISI. The last visible point on the right top corner of FIG. 10a, where the input EYE is about closed, shows and ISI input of 390 ps (the bit duration is 400 ps, without equalization 10 ps data valid) after equalization remains only 141 ps of ISI, consequently there is 239 ps valid for sampling (250 ps of ISI where suppressed). By extrapolating the curve of FIG. 10a one can understand that the equalizer will also re-open a closed input EYE. The equalizer due to the gain peaking and especially when Gpk is elevated, reacts to the input signal edge (dv/dt), rather than to the absolute value of the input signal. A change of 150/200 mV in one direction on the input differential signal will be sufficient to be analyzed as a valid 0 (when falling) or 1 (when rising). There is no need for the input signal to cross 0V differential voltage.

Controlling the ISI at 6 Gbit/s

FIG. 11a shows ISI rejection for the equalizer set for operating at 6 Gbit/s and FIG. 11b illustrates the eye “re-opening”. The power consumption is about 1.8 mA when the equalizer is implemented using a 0.12 um technology. Once again, the peak boost Gpk is set to a low value for optimizing the ISI rejection at low input jitter magnitude. It should be noticed that input ISI of 155 ps (as the last top right point on the curve below) denote an input EYE almost closed, the equalizer reopen the EYE at 68% UI at its output. It can be observed on FIG. 11a that last point on the top right side shows an input EYE about closed (remains 9 ps open for sampling from 166 ps bit duration) the ISI input is up to 156 ps, after equalization remains only 52 ps of ISI, consequently there is 104 ps valid sampling. At this point, one can conclude that without equalization the 6 Gbit link can not operate. As opposed getting a 104 ps open EYE post equalization, is very comfortable to get an operating and reliable 6 Gb link.

The Equalizer of the invention can be used to correct up to about 75% of the ISI, at a reasonable power consumption. It is implemented in the receiving die, preferably close to the sampler and deskewer. As a consequence, it is relatively easy for the deskewer to sense the EYE window so as to improve the equalizer tuning.

This invention can be implemented in any high speed application, and especially for Spi5 or NPSI domain, where the data is not encoded and consequently, the ISI (or data pattern dependent jitter) is potentially higher due to large signal bandwidth (DC to data rate).

The main advantages of the equalizer of the invention are: the compensation of a large portion of the input ISI (up to ⅔ to ¾); the reduced size and simplicity; the high frequency of the equalized signal (the equalizer is suitable for signals of 1 Gbit/s up to more than 6 Gbit/s in 0.12 um technology); and the low power consumption (e.g. less than 1 mW below 2.5 Gbits/s and 3 mW at 6 Gbits/s).

Naturally, in order to satisfy local and specific requirements, a person skilled in the art may apply to the solution described above many modifications and alterations all of which, however, are included within the scope of protection of the invention as defined by the following claims.

What is claimed is:

1. A low power equalizer for high speed signals having three amplifying stages serially connected, comprising a negative feedback loop from the third stage output to the second stage input for controlling the ISI, wherein,
the first stage is adapted to isolate the upstream circuit from said feedback;
the second stage comprises means for adjusting its variable gain with inherent common mode stabilization, for controlling signal peak boosting; and,
the third stage comprises means for applying the feedback to control the ISI by offering a gain peaking capability.

2. The low power equalizer of claim 1 wherein said means for adjusting the variable gain of said second stage allows a wide range of variation, a high gain of said second stage correcting high ISI and a low gain of said second stage correcting low ISI.

3. The low power equalizer of claim 2, wherein the output of said third stage is connected to ground through at least one variable capacitor for controlling the peak frequency of the signal gain.

4. The low power equalizer of claim 3 wherein the value of said at least one capacitor is increased for reducing the peaking frequency of the signal gain.

5. The low power equalizer of claim 4 wherein the peak frequency is set to approximately half the data rate.

6. The low power equalizer of claim 4 wherein the peak frequency is set to approximately ten percent above half the data rate.

7. The low power equalizer of claim 1 wherein said negative feedback loop comprises at least one variable resistor for adjusting the low power equalizer to the dynamic of the input signal.

8. The low power equalizer of claim 7 wherein the value of said at least one variable resistor is lowered when the dynamic of the input signal increases.

9. The low power equalizer of claim 1 adapted to process differential signals.

10. A Low power receiver comprising a low power equalizer having three amplifying stages serially connected, and further comprising a negative feedback loop from a third stage output to a second stage input for controlling the ISI, wherein,
the first stage is adapted to isolate the upstream circuit from said feedback;
the second stage comprises means for adjusting its variable gain with inherent common mode stabilization, for controlling signal peak boosting; and
the third stage comprises means for applying the feedback to control the ISI by offering a gain peaking capability.

11. The low power receiver of claim 10 wherein said means for adjusting the variable gain of said second stage provides a wide range of variation including a high gain of said second stage correcting high ISI and a low gain of said second stage correcting low ISI.

12. The low power receiver of claim 11, wherein the output of said third stage is connected to ground through at least one variable capacitor for controlling the peak frequency of the signal gain.

13. The low power receiver of claim 12 wherein the value of said at least one capacitor is increased for reducing the peaking frequency of the signal gain.

14. The low power receiver of claim 13 wherein the peak frequency is set to approximately half the data rate.

15. The low power receiver of claim 12 wherein the peak frequency is set to approximately ten percent above half the data rate.

16. The low power receiver of claim 11 wherein said negative feedback loop comprises at least one variable resistor for adjusting the low power equalizer to the dynamic of the input signal.

17. The low power receiver of claim 16 wherein the value of said at least one variable resistor is lowered when the dynamic of the input signal increases.

18. The low power receiver of claim 11 adapted to process differential signals.
